(19) United States
(12) Patent Application Publication
(10) Pub. No.: US 2025/0173735 A1
(43) Pub. Date: May 29, 2025

(54) MANAGEMENT SYSTEM CAPABLE OF AUTOMATICALLY CALCULATING THE CARBON EMISSION VALUE OF GOODS TRANSPORTATION AND DISTRIBUTION AND OPERATING PROCESS THEREOF

(71) Applicants: KENG-CHEN SHEU, Taichung City (TW); UniSmart Technology Co., Ltd., Taichung City (TW)

(72) Inventors: KENG-CHEN SHEU, Taichung City (TW); HSIANG-CHING CHANG, Keelung City (TW)

(21) Appl. No.: 18/953,292

(22) Filed: Nov. 20, 2024

(30) Foreign Application Priority Data
Nov. 23, 2023 (TW) 112145357

(51) Int. Cl. G06Q 30/018

(52) U.S. Cl. CPC G06Q 30/018

(57) ABSTRACT

A management system capable of automatically calculating a carbon emission value of goods transportation and distribution contains an input unit, a comparison calculation unit, a computing unit, and an output unit. The input unit is configured to input expense write-off application form information and a bill of lading (B/L). The comparison calculation unit is connected to the input unit and includes a transportation carbon emission coefficient comparison module and an automatic transportation distance calculation module. The computing unit is connected with the input unit and the comparison calculation unit to perform calculations based on the B/L, thus obtaining a transportation cost and a transportation carbon emission value. The output unit is connected to the computing unit to generate an expense write-off report based on the at least one of the land transportation fees, the sea transportation fees, and the air transportation fees.

### TECHNICAL FIELD

The present invention relates to a material management system and operating process thereof, and more particularly to a management system capable of automatically calculating a carbon emission value of goods transportation and distribution and an operating process thereof.

### BACKGROUND

Nowadays, the problem of global warming is getting increasingly serious causing changes in the earth's climate and environment, which will affect the survival of all kinds of creatures on the earth in the future. The problem of global warming is closely related to carbon emissions produced by humans. Countries around the world are actively calling for reducing carbon emissions and formulating various measures. However, the problem of global warming is gradually becoming more widespread. Although the general public is aware of the problem of global warming, they still lack vigilance. Accordingly, the call to reduce carbon emissions has not been effective in the daily lives of ordinary people. In the proportion of carbon emissions of various types of pollution, the carbon emissions of transportation vehicles are second only to industrial production and manufacturing. If the carbon emissions during material transportation can be reduced, it can have an effective impact on the reduction of carbon emissions. Therefore, countries around the world are all actively calling for the reduction of carbon emissions and formulating various “Carbon Footprint Verification” standards.

World-class brands such as APPLE company have successively required their supply chains to achieve carbon neutrality. The first step to carbon neutrality is carbon footprint verification. Carbon footprint verification uses scientific methods that comply with international standards to calculate the carbon emissions of various activities operated by the enterprise/organization itself. Although the carbon footprint verification report only needs to be disclosed to the public once a year, if desiring to determine whether the direction of carbon reduction is correct, it should always pay attention to a status of carbon emissions. If digital and automated system tools for carbon footprint verification can be further developed for carbon emission statistics, more accurate, complete and transparent scientific data on greenhouse gas emissions can be obtained more efficiently.

The three major emission categories of carbon footprint verification: refer to the three major categories of greenhouse gas emission categories classified according to the sources of greenhouse gas emissions. Category 1 refers to direct emissions from operating processes or facilities. Category 2 refers to indirect emissions from energy use of purchased electricity, heat or steam. Category 3 refers to emissions from emission sources that are not owned or controlled by the company, such as other indirect emissions caused by leasing, outsourcing, employee commuting, employee business trips, and upstream and downstream transportation and distribution of raw materials and finished products.

When most companies conduct annual greenhouse gas inventories, they only focus on Category 1 and Category 2 greenhouse gases. Many companies ignore Category 3 carbon inventories, but many industries emit the most carbon emissions in Category 3, such as manufacturing and services. Industries, etc., have many upstream and downstream supply chains or customers, or frequent upstream and downstream transportation and distribution of raw materials and finished products, employee commuting and employee official travel, which will make it difficult to accurately calculate greenhouse gas emissions of Category 3.

Although each company currently establishes a BOM (BOM is the abbreviation of Bill of Materials) internally, it is usually only used as a document for contact between the two parties of the Original Equipment Manufacturer (OEM) or for internal communication within the company. Statistics on carbon emissions from transportation and distribution must be manually collected for each item afterward. Domestic and international freight documents for transportation and distribution of sub-raw materials and a rough calculation of their corresponding carbon emissions. However, because of the different countries, regions or cities used for transportation and distribution, and the different means of transportation used (such as container trucks, trucks, freight wagons, home delivery vehicles, railways, freighters or cargo planes), a manual operating process of collecting statistics and preparing relevant supporting information after the story is quite cumbersome and time-consuming. At present, there is no integration of upstream and downstream transportation and distribution digital systems to conduct carbon footprint verification of goods transportation and distribution. Enterprises are unable to formulate encouragement and reward measures for the transportation and distribution of carbon reduction. Therefore, a call for transportation and distribution of carbon reduction within the enterprise is ineffective.

The present invention has arisen to mitigate and/or obviate the afore-described disadvantages.

### SUMMARY

The primary aspect of the present invention is to provide a management system capable of automatically calculating a carbon emission value of goods transportation and distribution and an operating process thereof which are applied to integrate the upstream and downstream transportation and distribution digital systems to conduct a transportation and distribution carbon footprint verification. When using the operating process, expense write-off application form information and a bill of lading (B/L) are entered to automatically calculate the carbon emission value of the goods shipped by the land transportation, sea transportation, air transportation or multimodal transportation. It is helpful for enterprises to make transportation and distribution carbon emission encouragement and reward measures, and to improve the effectiveness of transportation and distribution carbon reduction in the enterprises.

To obtain the above-mentioned aspect, a management system capable of automatically calculating a carbon emission value of goods transportation and distribution provided by the present invention contains an input unit, a comparison calculation unit, a computing unit, and an output unit.

The input unit is configured to input expense write-off application form information and a bill of lading (B/L). The B/L is at least one of a land waybill, a sea waybill and an air waybill. Alternatively, the B/L is a multimodal transport loading bill, and the multimodal transport loading bill is a bill of at least two modes of transportation applicable for a land transportation, a sea transportation, and an air transportation, thus obtaining a combined transportation and applying it to an entire transportation. According to the United Nations Convention on International Multimodal Transport of Goods, the definition of international multimodal transport is: using at least two different modes of transportation, the multimodal shipper transports the goods from the transportation of goods from a take-over point in one country to a designated delivery point in another country. This method reduces the handling of goods, thereby improving safety, reducing damage and losses, and making the transportation of goods faster.

The comparison calculation unit is connected to the input unit and includes a transportation carbon emission coefficient comparison module and an automatic transportation distance calculation module. The transportation carbon emission coefficient comparison module includes a vehicle per ton-kilometer carbon emission coefficient comparison module which is configured to compare and obtain transportation means carbon emission coefficient information/per ton-kilometer. The input unit is connected to the automatic transportation distance calculation module through a network to automatically calculate a distance information between two transportation places.

The computing unit is connected with the input unit and the comparison calculation unit to perform calculations based on the B/L, thus obtaining a transportation cost and a transportation carbon emission value. The transportation cost includes at least one of a land transportation fee, a sea transportation fee, and an air transportation fee. The transportation carbon emission value includes at least one of a land transportation carbon emission value, a sea transportation carbon emission value, and an air transportation carbon emission value. The land transportation carbon emission value is obtained by calculating a carbon emission coefficient per ton-kilometer of the transportation means and transportation distance information, the sea transportation carbon emission value is obtained through a carbon emission calculation module of an external shipping company, and the air transportation carbon emission value is obtained through a carbon emission calculation module of an external airline company.

The output unit is connected to the computing unit to generate an expense write-off report based on the at least one of the land transportation fees, the sea transportation fees, and the air transportation fees. Also, the output unit is configured to generate a transportation carbon emission report by calculating the at least one of the land transportation carbon emission values, the sea transportation carbon emission value, and the air transportation carbon emission values.

An operating process of the management system capable of automatically calculating the carbon emission value of the goods transportation and distribution according to the preferred embodiment of the present invention contains:
(a1) an inputting step, wherein the input unit is configured to input the expense write-off application form information and the land waybill;
(a2) a comparing the carbon emission coefficient of transportation means step, wherein the transportation country, an energy type and the transportation means are entered from the expense write-off application form and the land waybill, and carbon emission coefficient information/per ton-kilometer transportation is compared based on the transportation carbon emission coefficient database of various countries by using the vehicle per ton-kilometer carbon emission coefficient comparison module;
(a3) an automatically calculating transportation distance step, wherein an original, a destination and the transportation means are entered in the expense write-off application form and the land waybill, and the automatic transportation distance calculation module automatically calculates the transportation distance information between the two transportation places by connecting with the network (a unit is metric kilometers or imperial miles);
(a4) a calculating step: wherein the land transportation fee is calculated through the computing unit based on the land waybill, compared carbon emission coefficient information/per ton-kilometer transportation and an automatically calculated distance information between the two transportation places, the land transportation carbon emission value is calculated by the computing unit; and
(a5) an outputting step, wherein the output unit generates the expense write-off report based on the land transportation fee, and the transportation carbon emission report is generated based on the land transportation carbon emission value.

In another embodiment, an operating process of the management system capable of automatically calculating the carbon emission value of the goods transportation and distribution contains:
(b1) an inputting step, wherein the input unit is configured to input the expense write-off application form information and the land waybill;
(b2) a comparing the carbon emission coefficient of transportation means step, wherein the transportation country, the energy type, and the transportation means are entered from the expense write-off application form and the land waybill, and the carbon emission coefficient information per energy measurement unit of transportation is compared based on the transportation carbon emission coefficient database of various countries by using the vehicle per energy-measurement-unit energy type carbon emission coefficient comparison module;
(b3) a calculating step, wherein the land transportation fee is calculated based on the land waybill by using the computing unit, and the land transportation carbon emission value is calculated based on compared carbon emission coefficient information per energy measurement unit of the transportation means and a total energy amount of the land waybill by using the computing unit; and
(b4) an outputting step, wherein the output unit generates the expense write-off report based on the land transportation fee, and the transportation carbon emission report is generated based on the land transportation carbon emission value.

In another embodiment, an operating process of the management system capable of automatically calculating the carbon emission value of the goods transportation and distribution contains:
(c1) an inputting step, wherein the input unit is configured to input the expense write-off application form information and the sea waybill;
(c2) a calculating step, wherein the sea transportation fee is calculated based on the sea waybill by using the computing unit, and the sea transportation carbon emission value is calculated based on entered information of the expense write-off application form information and the sea waybill by connecting the computing unit to the shipping company's carbon emission calculation module to calculate the sea transportation carbon emission value; and
(c3) an outputting step, wherein the output unit generates the expense write-off report based on the sea transportation fee, and the transportation carbon emission report is generated based on the sea transportation carbon emission value.

In another embodiment, an operating process of the management system capable of automatically calculating the carbon emission value of the goods transportation and distribution contains:
(d1) an inputting step, wherein the input unit is configured to input the expense write-off application form information and the air waybill;
(d2) a calculating step, wherein the air transportation fee is calculated based on the air waybill by using the computing unit, and the air transportation carbon emission value is calculated based on entered information of the expense write-off application form information and the air waybill by connecting the computing unit to the airline carbon emission calculation module to calculate the air transportation carbon emission value; and
(d3) an outputting step, wherein the output unit generates the expense write-off report based on the air transportation fee, and the transportation carbon emission report is generated based on the air transportation carbon emission value.

In another embodiment, an operating process of the management system capable of automatically calculating the carbon emission value of the goods transportation and distribution contains:
(e1) an inputting step, wherein the input unit is configured to input at least two of the expense write-off application form information, the land waybill, the sea waybill and the air waybill;
(e2) a comparing the carbon emission coefficient of transportation means step, wherein the transportation country, the energy type and the transportation means are entered from the expense write-off application form and the land waybill, the carbon emission coefficient information of transportation vehicles per ton-kilometer is compared based on the transportation carbon emission coefficient database of various countries by using the vehicle per ton-kilometer carbon emission coefficient comparison module, or the carbon emission coefficient information per energy measurement unit of transportation is compared based on the transportation carbon emission coefficient database of various countries by using the vehicle per energy-measurement-unit energy type carbon emission coefficient comparison module to obtain information on carbon emission coefficient per energy measurement unit of transportation vehicles;
(e3) an automatically calculating transportation distance step, wherein the original, the destination and the transportation means are entered in the expense write-off application form and the land waybill, and the automatic transportation distance calculation module automatically calculates the transportation distance information between the two transportation places by connecting with the network;
(e4) a calculating step, wherein the land transportation fee is calculated through the computing unit based on the land waybill, and/or the sea transportation fee is calculated based on the sea waybill by using the computing unit, and/or the air transportation fee is calculated based on the air waybill by using the computing unit, and based on the compared carbon emission coefficient information/per ton-kilometer transportation and the automatically calculated distance information between the two transportation places, or the carbon emission coefficient information per energy measurement unit of transportation, and the total energy amount of the land waybill, wherein the land transportation carbon emission value is calculated by using the computing unit, and/or inputted information from the expense write-off application form information and the sea waybill, and the sea transportation carbon emission value is calculated by connecting the computing unit to the shipping company's carbon emission calculation module, and/or inputted information from the expense write-off application form information and the air waybill, the air transportation carbon emission value is calculated by connecting the computing unit to the airline carbon emission calculation module, and land transportation fee is added to the sea transportation fee, or the land transportation fee is added to the air transportation fee, or the land transportation fee, the sea transportation fee and the air transportation fee are added to form the transportation cost, and the land transportation carbon emission value is added to the sea transportation carbon emission value or the land transportation carbon emission value is added to the air transportation carbon emission value or the land transportation carbon emission value, the sea transportation carbon emission value and the air transportation carbon emission value are added to form the transportation carbon emission value based on the land waybill and the sea waybill or the land waybill and the air waybill or the land waybill, the sea waybill and the air waybill; and
(e5) an outputting step, wherein the output unit generates the expense write-off report based on the transportation cost, and the transportation carbon emission report is generated based on the transportation carbon emission value.

### BRIEF DESCRIPTION OF THE DRAWINGS

FIG. 1 is a schematic view showing the assembly of a management system capable of automatically calculating a carbon emission value of goods transportation and distribution according to a preferred embodiment of the present invention.

FIG. 2 is a schematic view of expense write-off application form information according to the preferred embodiment of the present invention.

FIG. 3 is a schematic view of the bill of lading form information according to the preferred embodiment of the present invention.

FIG. 4 is a schematic view of a land waybill according to the preferred embodiment of the present invention.

FIG. 5 is a schematic view of a sea waybill according to the preferred embodiment of the present invention.

FIG. 6 is a schematic view of an air waybill according to the preferred embodiment of the present invention.

FIG. 7 is a schematic view of a transportation means according to the preferred embodiment of the present invention.

FIG. 8 is a schematic view of a transportation carbon emission coefficient comparison module according to the preferred embodiment of the present invention.

FIG. 9 is a schematic view of a production management system according to the preferred embodiment of the present invention.

FIG. 10 is a schematic view of a carbon emission management of supply chain transportation according to the preferred embodiment of the present invention.

FIG. 11 is a schematic view of a combination of an intermodal transportation according to the preferred embodiment of the present invention.

FIG. 12 is a schematic view of an automatic transportation distance calculation module according to the preferred embodiment of the present invention.

FIG. 13 is a schematic view of the corresponding Google Maps generated based on FIG. 12 according to the preferred embodiment of the present invention.

FIG. 14 is a schematic view of a shipping company's carbon emission calculation module according to the preferred embodiment of the present invention.

FIG. 15 is a schematic view of an airline carbon emission calculation module according to the preferred embodiment of the present invention.

FIG. 16 is a flow chart of an automatic calculation of carbon emissions and a write-off expenses for a land transportation according to another preferred embodiment of the present invention.

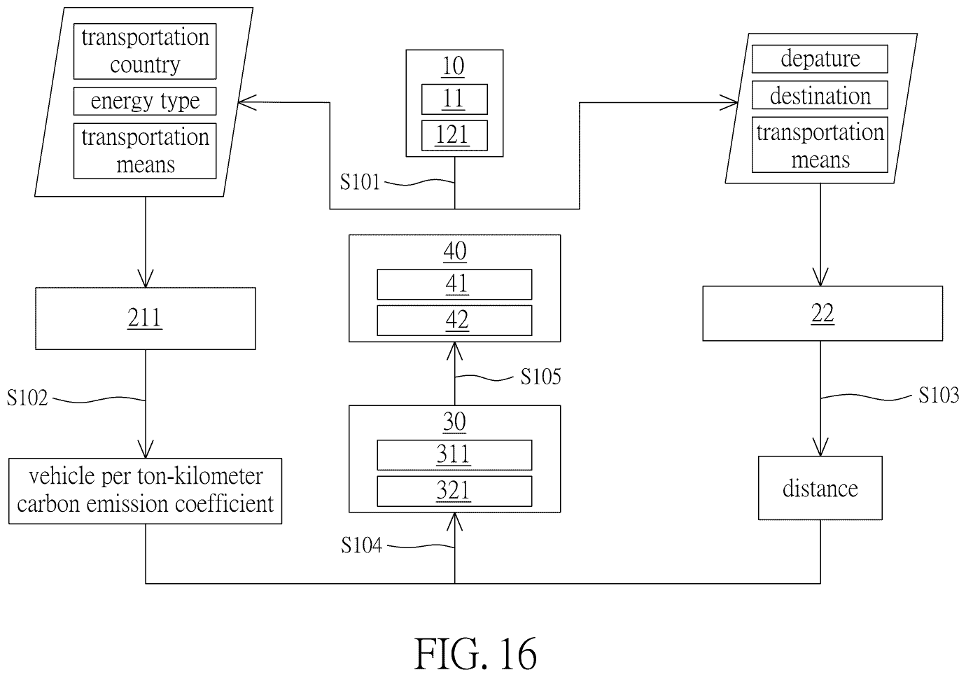

FIG. 17 is another flow chart of the automatic calculation of carbon emissions and the write-off expenses for the land transportation according to another preferred embodiment of the present invention.

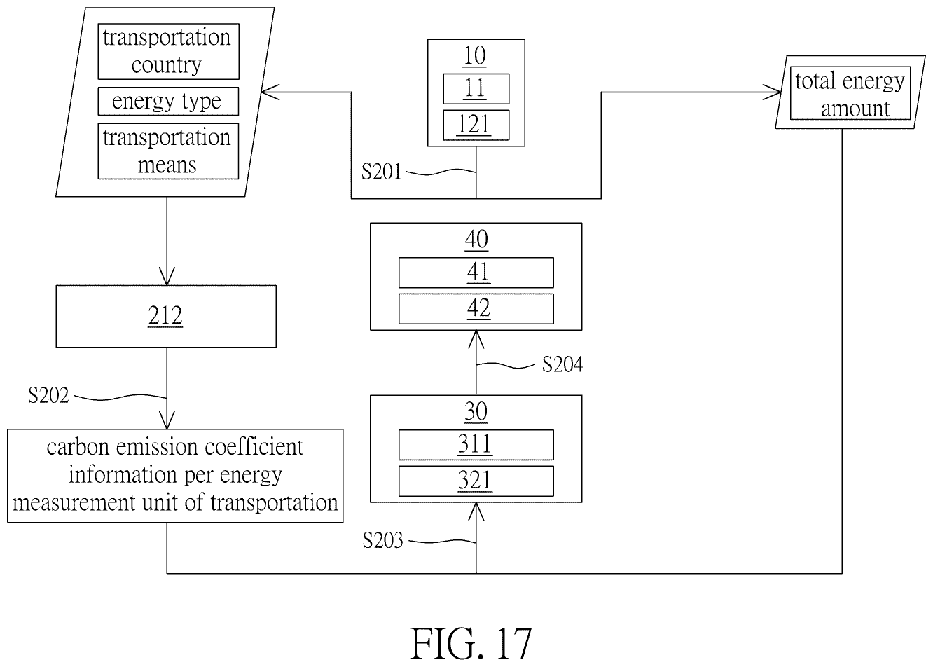

FIG. 18 is a flow chart of an automatic calculation of carbon emissions and a write-off expenses for a sea transportation according to another preferred embodiment of the present invention

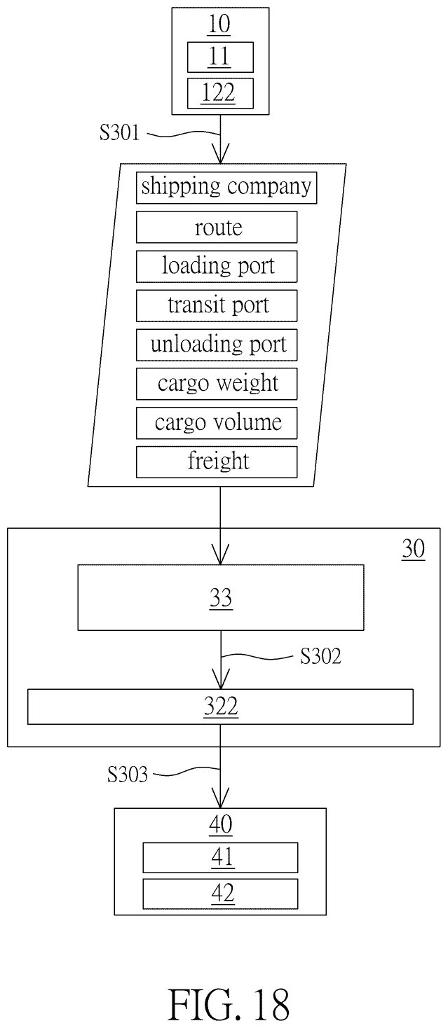

FIG. 19 is a flow chart of an automatic calculation of carbon emissions and a write-off expenses for an air transportation according to another preferred embodiment of the present invention

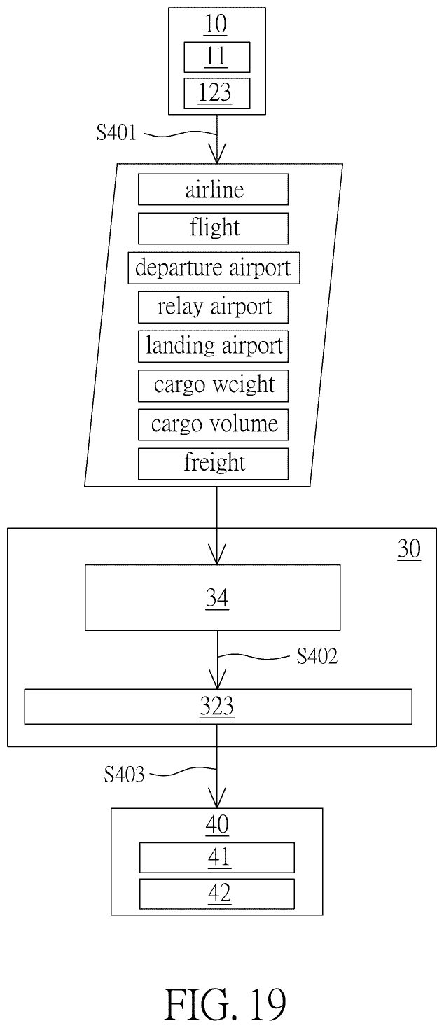

FIG. 20 is a flow chart of a multimodal transportation automatically calculates carbon emissions according to the preferred embodiment of the present invention.

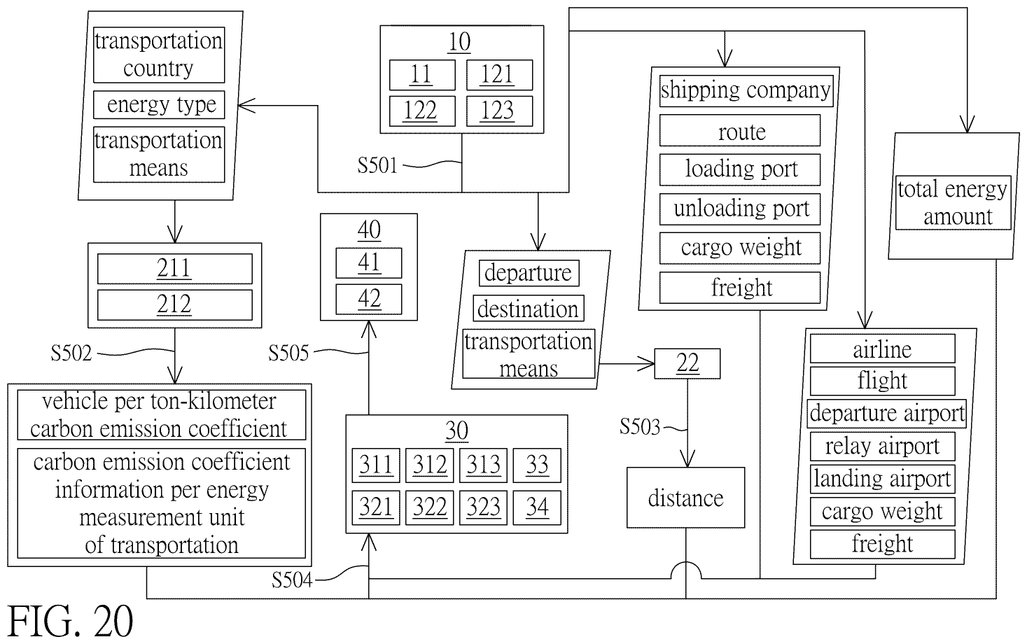

FIG. 21 is another flow chart of a multimodal transportation automatically calculates carbon emissions according to the preferred embodiment of the present invention.

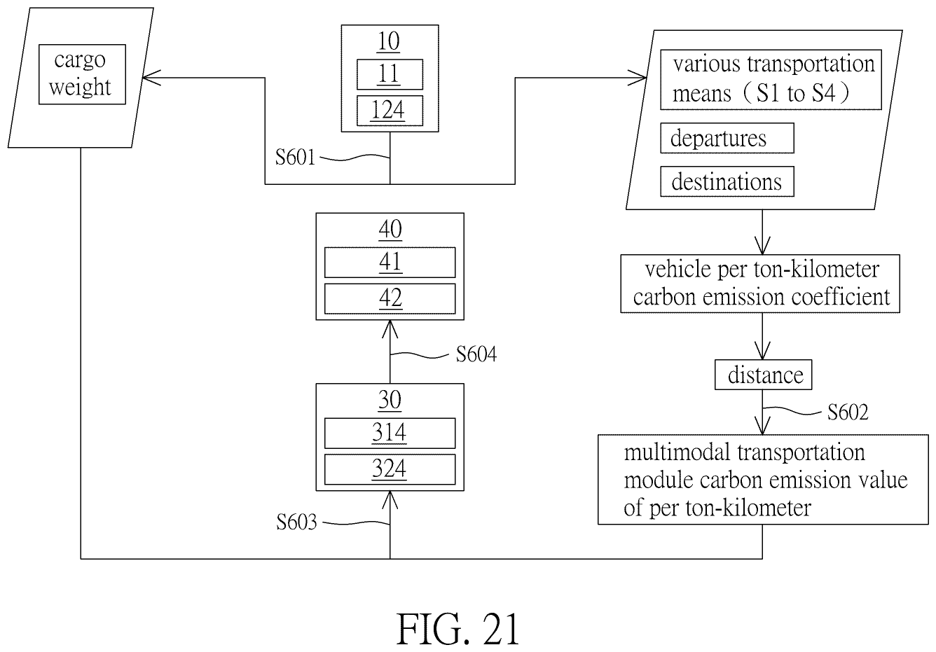

### DETAILED DESCRIPTION

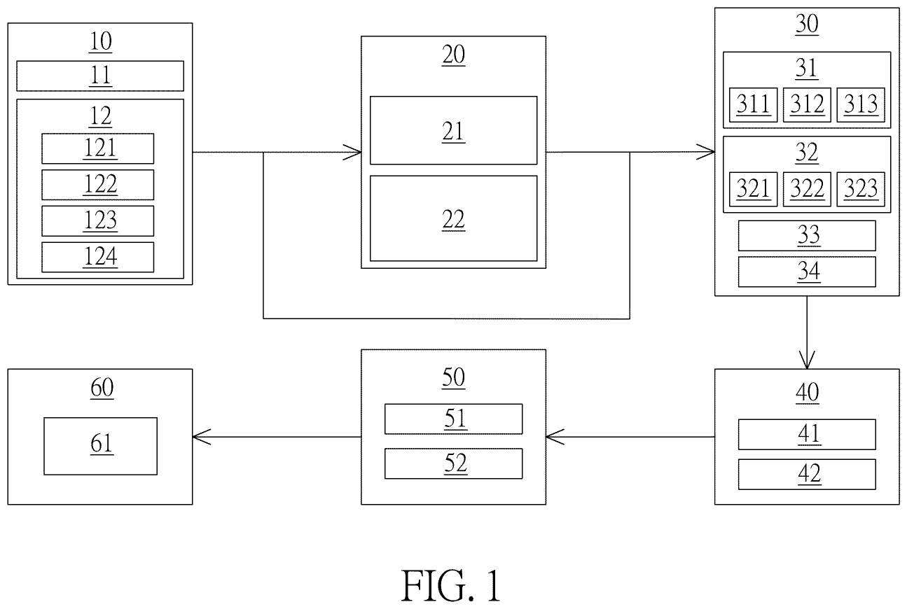

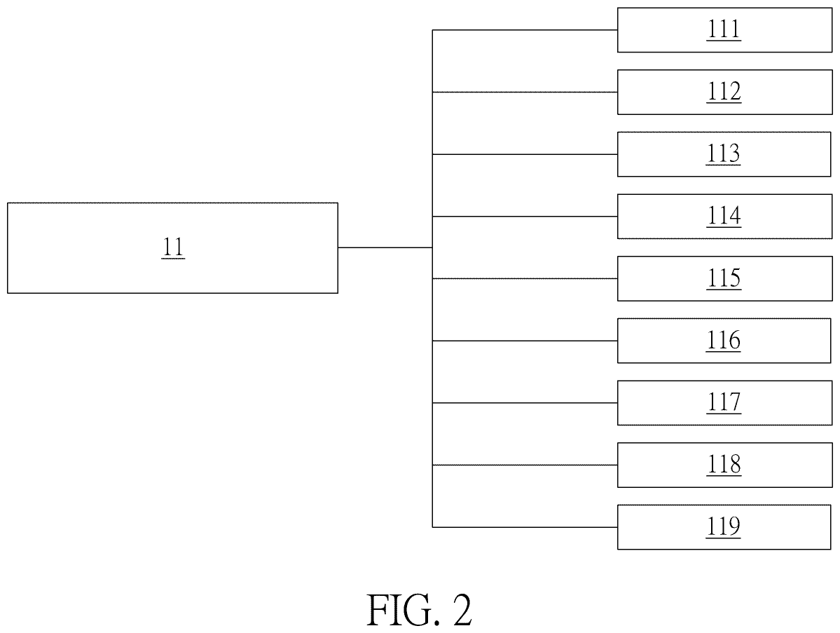

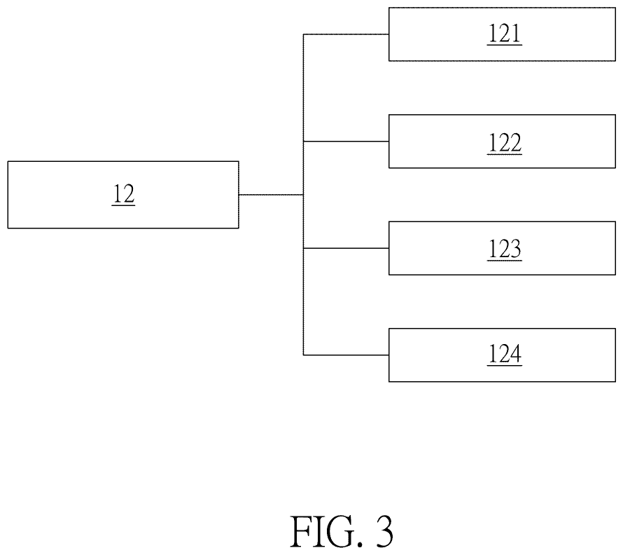

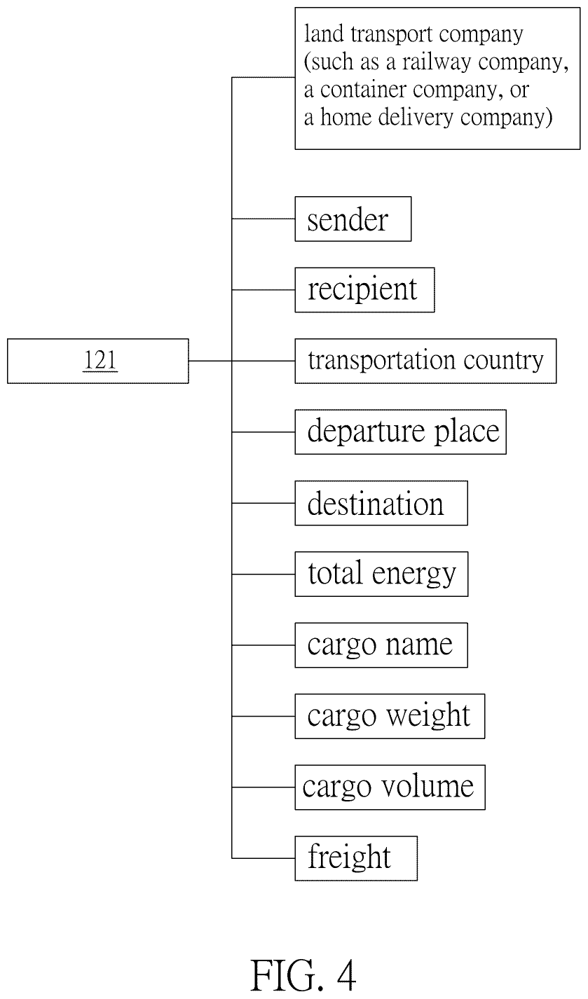

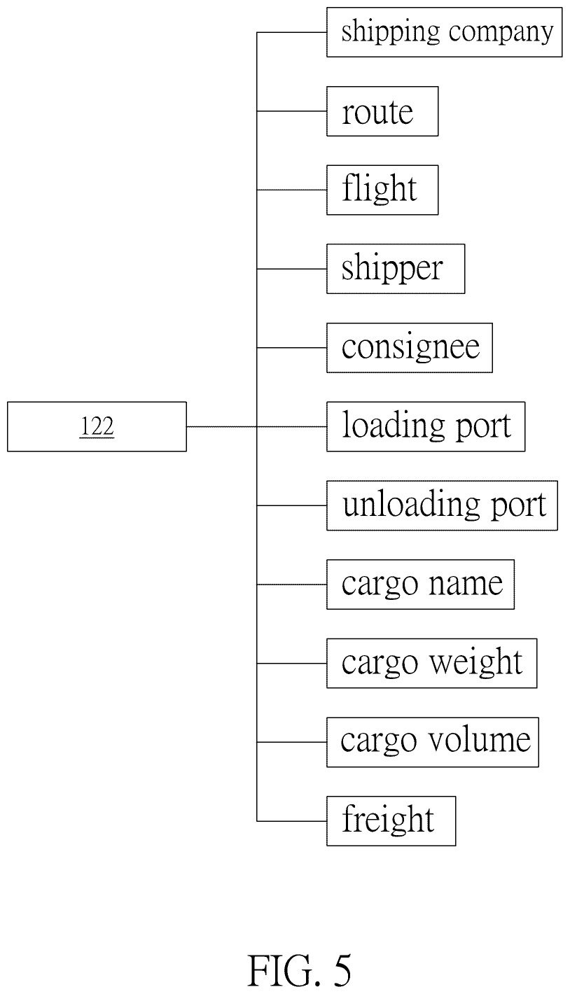

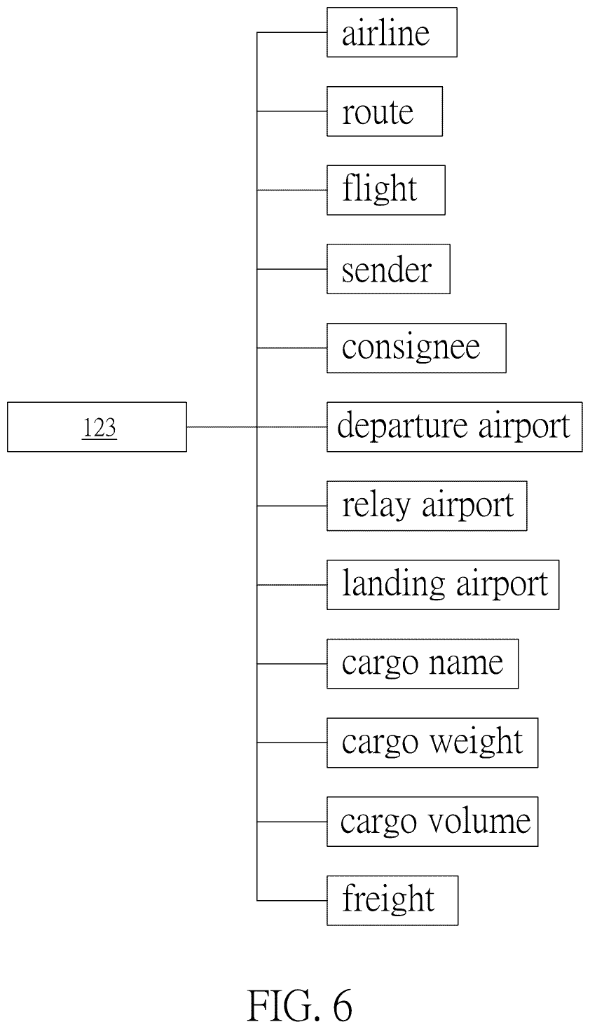

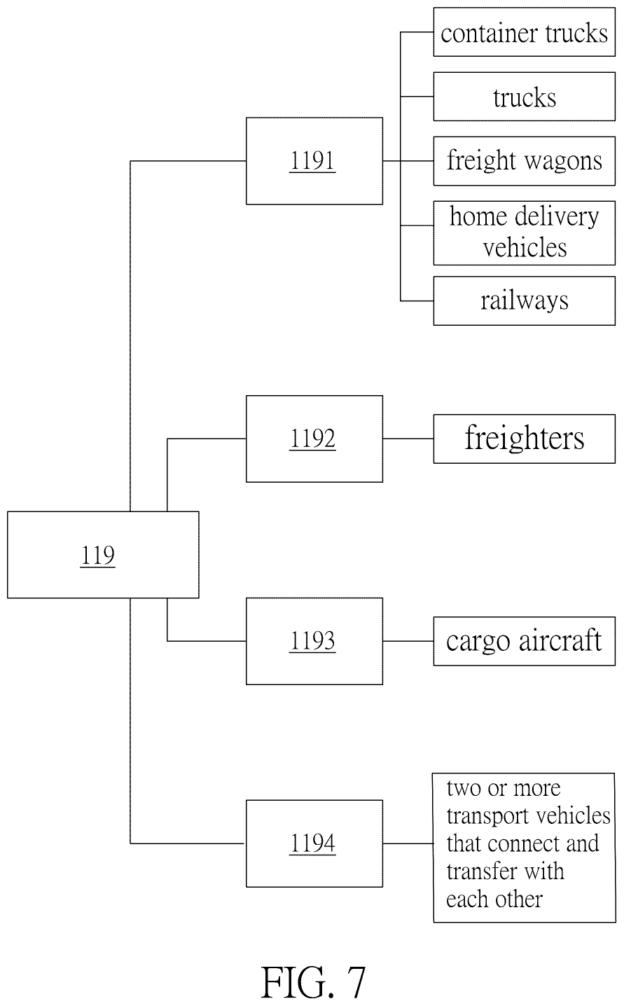

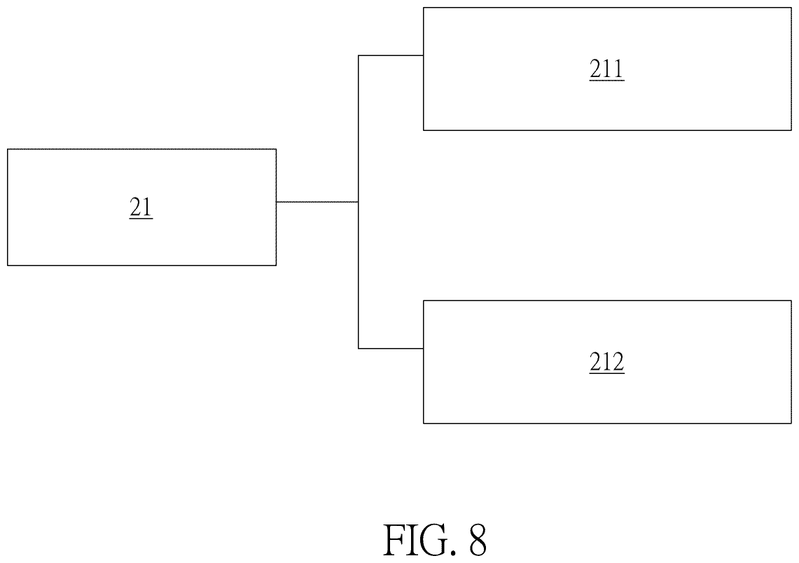

With reference to FIGS. 1-15, a management system capable of automatically calculating a carbon emission value of goods transportation and distribution according to a preferred embodiment of the present invention comprises an input unit 10, a comparison calculation unit 20, a computing unit 30, an output unit 40, a check unit 50 and a write-off unit 60.

The input unit 10 is configured to input expense write-off application form information 11 and a bill of lading 12 (B/L, which is a legally valid document. It is a certificate of ownership of the goods and a transportation contract made between a shipper and a carrier). The expense write-off application form information 11 includes an application unit 111, a purchase order 112, a shipping order 113, an upstream supply chain manufacturer 114, a downstream customer name 115, a cargo name 116, a cargo quantity 117, a cargo weight 118 and a transportation means 119. The B/L 12 is at least one of a land waybill 121, a sea waybill 122 and an air waybill 123, or the B/L 12 is a multimodal transport loading bill 124. The multimodal transport loading bill 124 is a bill of at least two modes of transportation applicable for a land transportation, a sea transportation, and an air transportation. The land waybill 121 includes a land transport company (such as a railway company, a container company, or a home delivery company), a sender, a recipient, a transportation country, a departure place, a destination, the transportation means, a total energy, a cargo name, a cargo weight, a cargo volume, and a freight. The sea waybill 122 includes a shipping company, a route, a flight, a shipper, a consignee, a loading port, an unloading port, a cargo name, a cargo weight, a cargo volume, and a freight. The air waybill 123 includes an airline, a route, a flight, a sender, a consignee, a departure airport, a relay airport, a landing airport, a cargo name, a cargo weight, and a cargo volume, and a freight. The transportation means 119 including a land transportation means 1191, a sea transportation means 1192, an air transportation means 1193 and a multimodal transportation means 1194. The land transportation means 1191 also includes container trucks, trucks, freight wagons, home delivery vehicles, and railways, and the sea transportation means 1192 includes freighters. The air transportation means 1193 includes a cargo aircraft. The multimodal transportation means 1194 includes two or more transport vehicles that connect and transfer with each other to complete a transportation operating process together.

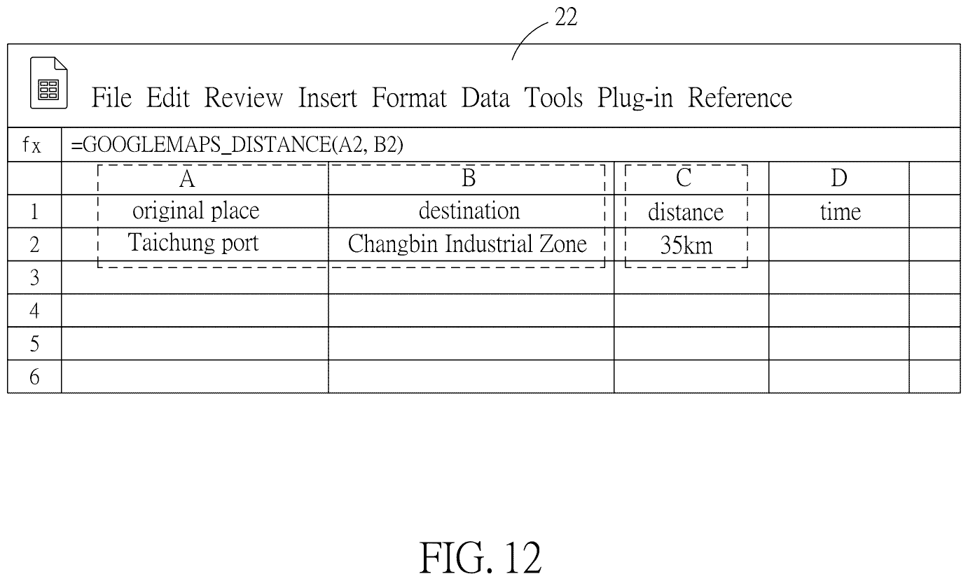

The comparison calculation unit 20 is connected to the input unit 10 and includes a transportation carbon emission coefficient comparison module 21 and an automatic transportation distance calculation module 22. The transportation carbon emission coefficient comparison module 21 includes a vehicle per ton-kilometer carbon emission coefficient comparison module 211 and a vehicle per energy-measurement-unit energy type carbon emission coefficient comparison module 212. The vehicle per ton-kilometer carbon emission coefficient comparison module 211 is configured to compare and obtain the transportation means carbon emission coefficient information/per ton-kilometer. The vehicle per energy-measurement-unit energy type carbon emission coefficient comparison module 212 is configured to compare and obtain the transportation means carbon emission coefficient/per energy measurement unit, and the vehicle per ton-kilometer carbon emission coefficient comparison module 211 and the vehicle per energy-measurement-unit energy type carbon emission coefficient comparison module 212 is edited or updated according to a latest carbon emission coefficient published by the transportation country or based on a built-in database. The automatic transportation distance calculation module 22 is an external program. The input unit 10 is connected to the automatic transportation distance calculation module 22 through a network to automatically calculate distance information between two transportation places. In this embodiment, the automatic transportation distance calculation module 22 uses a Google calculator (as shown in FIG. 12). The Google calculator is combined with a Google Map to automatically calculate the distance between two transportation places and other information (a unit is a metric kilometer or an imperial miles), it could enter the following formula to let the Google function automatically calculate the “distance” field: =GOOGLEMAPS_DISTANCE (“origin”, “destination”), for example: =GOOGLEMAPS_DISTANCE (A2, B2), or: =GOOGLEMAPS_DISTANCE (“Taichung Port”, “Changbin Industrial Zone”), it automatically calculates a result that the distance between the two transportation places is 35 KM.

The computing unit 30 is connected with the input unit 10 and the comparison calculation unit 20 to perform calculations based on the B/L 12, thus obtaining a transportation cost 31 and a transportation carbon emission value 32. The transportation cost 31 includes at least one of a land transportation fee 311, a sea transportation fee 312, and an air transportation fee 313. The transportation carbon emission value 32 includes at least one of a land transportation carbon emission value 321, a sea transportation carbon emission value 322, and an air transportation carbon emission value 323, wherein the land transportation carbon emission value 321 is obtained by calculating a carbon emission coefficient per ton-kilometer of the transportation means and transportation distance information, or by calculating a carbon emission coefficient per energy measurement unit of a transportation means and a total energy amount of the land waybill 121. The sea transportation carbon emission value 322 is obtained through a network connection with a carbon emission calculation module of an external shipping company. The air transportation carbon emission value 323 is obtained through a network connection with a carbon emission calculation module of an external airline company. In this embodiment, a shipping company's carbon emission calculation module 33 is the Evergreen Marine Carbon Emission Calculator (https://csr.evergreen-marine.com/csr/tw/jsp/CSR_CarbonCalculator.jsp), 1 TEU cargo Transported by Evergreen Line from Taiwan-Taichung Port to Japan-Kobe Port, the distance is 1977.9 kilometers. Its carbon emissions are 174 kilograms. An airline carbon emission calculation module 34 is an example of China Airlines' carbon footprint calculation tool (https://china-airlines.co2analytics.com/calculate-your-footprint-2). 1 metric ton of cargo is transported by a China Airlines cargo plane from Taoyuan Airport in the Republic of China. At Incheon Airport in South Korea, the carbon emissions generated were 0.91 tons of CO2e.

To automatically calculate a carbon emissions generated by freights, various shipping companies around the world provide global customers with advanced dynamic carbon emissions calculation tools based on the dynamic data of actual operating ships. Thereby, customers apply cargo volume, mileage and optimized EEOI parameters to calculate and evaluate the carbon emissions generated by external freights. At present, various shipping company websites around the world will gradually establish their carbon emission computer systems. This system can be obtained by connecting to external shipping company carbon emission calculation modules 33 calculations.

To automatically calculate carbon emissions generated by freight, airlines around the world apply a flight carbon footprint calculation method proposed by the International Civil Aviation Organization (ICAO) and the International Air Transport Association (IATA), wherein a key coefficient uses an actual flight fuel of a flight, a number of seats of each aircraft type and an actual revenue of each cabin class to carry passengers/cargo data, thus calculating “actual” carbon emissions generated by a freight transportation. At present, a variety of airline websites around the world gradually establishing their carbon footprint calculation tool systems respectively. Such systems are obtained to calculate by connecting to the airline carbon emission calculation module 34.

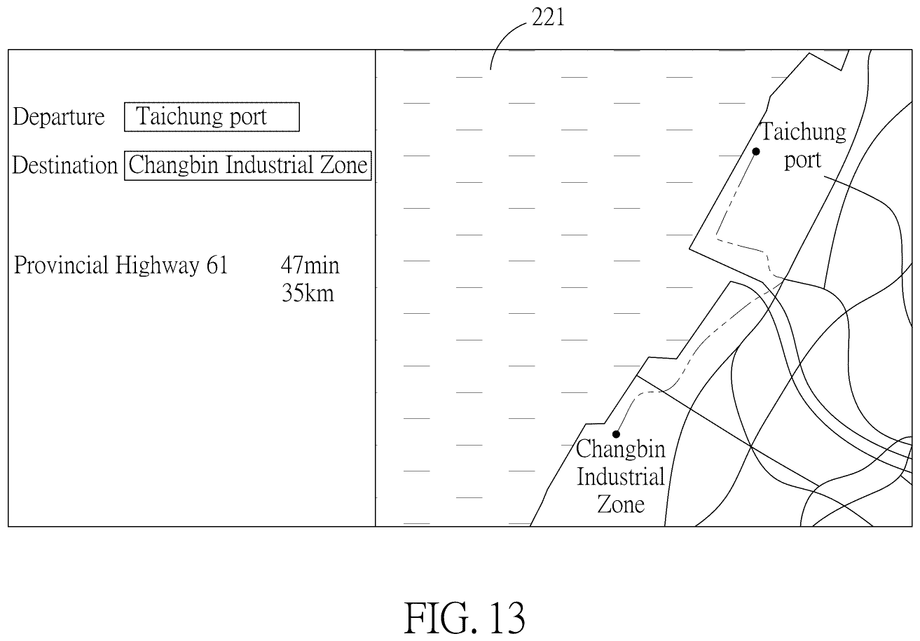

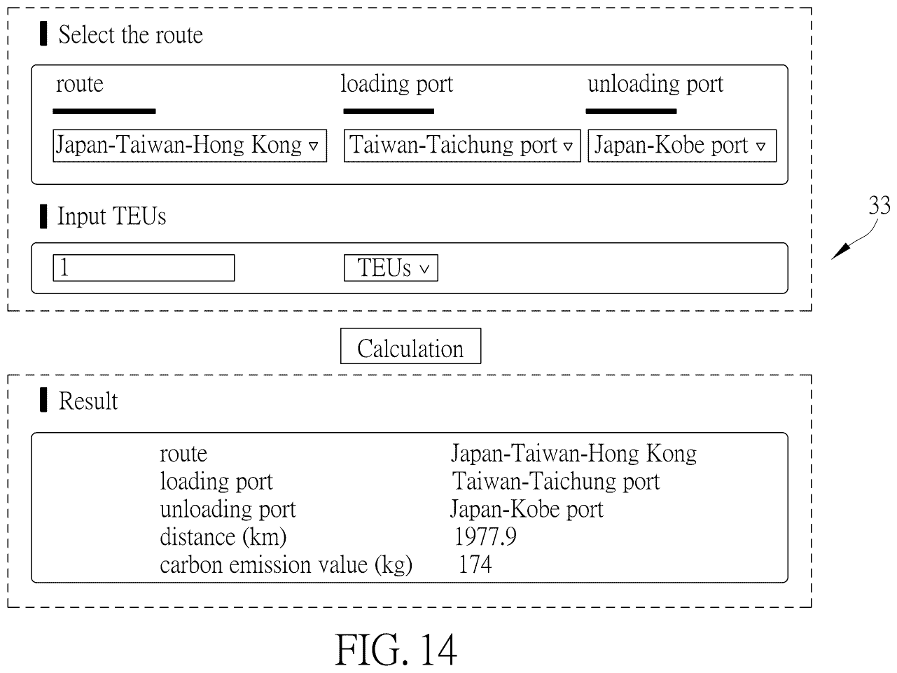

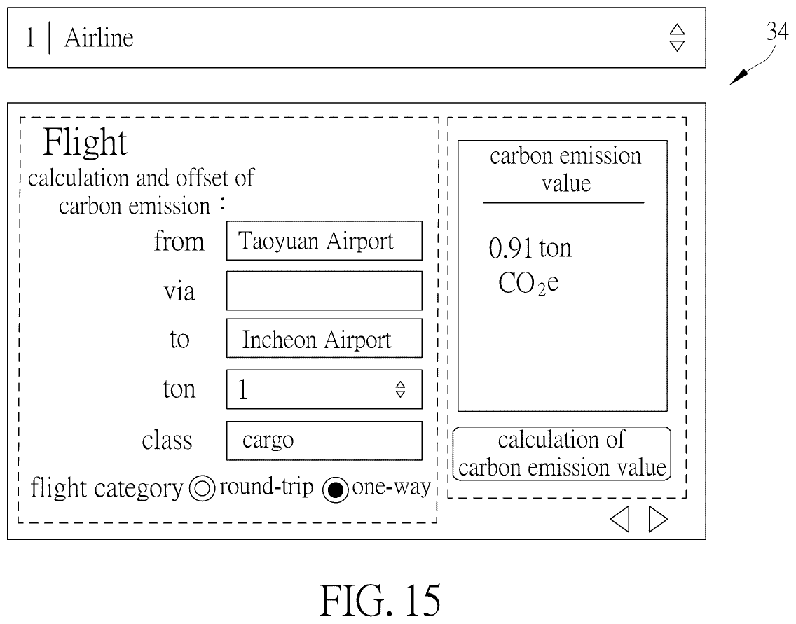

Regarding the automatic transportation distance calculation module 22 is shown in FIG. 12 to take the Google calculation sheet as an example. The shipping company's carbon emission calculation module 33 is shown in FIG. 14 to take the Evergreen Marine Carbon Emissions Calculator as an example. The airline carbon emission calculation module 34 is shown in FIG. 15 to take the China Airlines' carbon footprint calculation tool as an example, wherein an entire calculation operating process is automatically performed through the XML (extensible Markup Language) interface that is connected between the input unit and the carbon emission calculation system. Also, the XML-based interface is designed to complete automatic data storage and data transmission. Taking the automatic transportation distance calculation module 22 of transportation distance using Google calculation sheet as an example, as shown in a dotted block diagram on a left side of FIG. 12, fields such as a departure (A) and a destination (B) are inputted from the input unit 10. Through a XML interface design, the departure (A) and the destination (B) are saved and transmitted to the automatic transportation distance calculation module 22, and the distance information between the two transportation places are automatically calculated and saved in a column (C) (as shown in the dotted block diagram on a right side of FIG. 12) Through the XML interface design, data of the column (C) is saved and transmitted to the computing unit 30, and a corresponding Google Maps map 221 (as shown in FIG. 13) is further generated, wherein its map image is captured for carbon emission calculation. supporting information. For the company's transportation and distribution data of many raw materials in the current year, programming are configured to sequentially generate columns of a series of the departure (A) and the destination (B) from the input unit 10, and it further allows the Google function to automatically calculate a series of the distance information on the column (C).

Taking the shipping company's carbon emission calculation module 33 using the Evergreen Marine Carbon Emission Calculator as an example, as shown in a dotted-line block diagram on an upper side of FIG. 14, the columns include a route, a loading port, an unloading port and a number of input TEUs (a unit is TEUs, TONs or FEUs) is input from the input unit 10. Through the XML interface design, the data are saved and transmitted to the network to connect the shipping company's carbon emission calculation module 33 and to automatically calculate a shipping trip. A corresponding carbon emission value generated from the shipping trip is automatically calculated (as shown in a dotted-line block diagram at the bottom of FIG. 14). Then, through the XML interface design, the sea transportation carbon emission value 322 is saved and transmitted to the computing unit 30, and image of FIG. 14 are further generated as supporting data for a carbon emission calculation.

Take the airline carbon emission calculation module 34 using the China Airlines carbon footprint calculation tool as an example. As shown in a dotted-line block diagram on the left side of FIG. 15, columns of FIG. 15 include a departure airport, a relay airport, a landing airport, a tonnage, a cabin class and shipping trip type (a round trip or one way) are input from the input unit 10. Through the XML interface design, the data are saved and transmitted to the airline carbon emission calculation module 34 connected to the network, and a corresponding carbon emission value generated by the flight is automatically calculated (as shown in a dotted-line block diagram on a right side of FIG. 15). Thereafter, through the XML interface design, the air transportation carbon emission value 323 is saved and transmitted to the computing unit 30, and FIG. 15 is captured for supporting information of carbon emissions calculations.

Regarding the vehicle per ton-kilometer carbon emission coefficient comparison module 211 and the vehicle per energy-measurement-unit energy type carbon emission coefficient comparison module 212, their carbon emission coefficients of transportation means are different based on various countries and years. In other words, the emission coefficient data of different transportation means in each country is dynamically updated with time and technological development. This system is configured to edit or update the system's built-in database according to the latest carbon emission coefficient published by the transportation country.

The output unit 40 is connected to the computing unit 30 to generate an expense write-off report 41 based on the at least one of the land transportation fee 311, the sea transportation fee 312, and the air transportation fee 313. Also, the output unit 40 is configured to generate a transportation carbon emission report 42 by calculating the at least one of the land transportation carbon emission value 321, the sea transportation carbon emission value 322, and the air transportation carbon emission value 323.

The check unit 50 includes a supervisor audit 51 and a carbon emission audit 52. The supervisor audit 51 is configured to check the expense write-off report 41, and the carbon emission audit 52 is configured to check the transportation carbon emission report 42.

The write-off unit 60 includes an accounting write-off 61, and the accounting write-off 61 is configured to perform an expense write-off based on the expense write-off report 41.

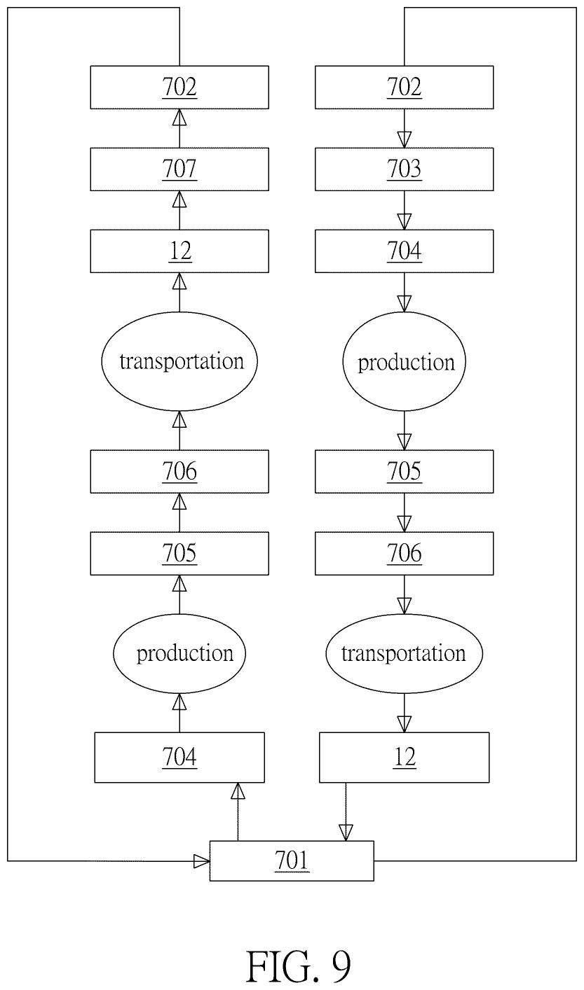

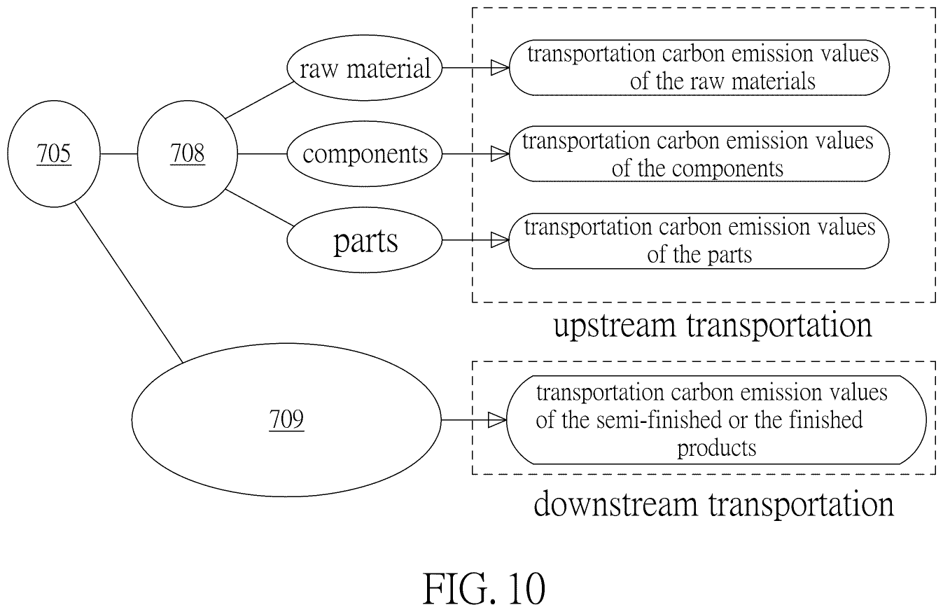

A manufacturing operating process is shown in FIGS. 9 and 10, wherein a manufacturer 701 issues a purchase order 702 to a supplier 703, and the supplier 703 issues a work order 704 to produce goods 705. The supplier 703 then issues a shipping order 706, and cooperates with the B/L 12 through a transportation and a distribution, wherein the goods 705 are delivered to the manufacturer 701, and a customer 707 issues the purchase order 702 to the manufacturer 701, and the manufacturer 701 issues the work order 704 to produce the goods 705, then the manufacturer 701 issues the shipping order 706 and cooperates with the B/L 12 through the transportation and the distribution, wherein the goods 705 are delivered to the customer 707. The goods 705 are any one of raw materials, components, parts listed in the BOM list 708, semi-finished products and finished products 709. The transportation carbon emission values of the raw materials, components, parts, and the semi-finished or the finished products 709 listed in the BOM table 708 are calculated respectively according to this system.

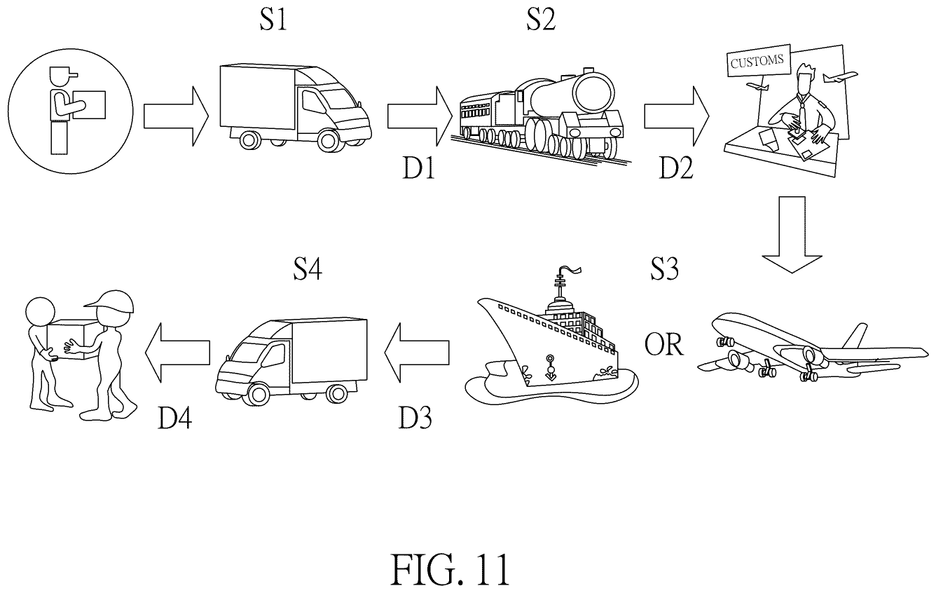

Regarding the embodiment of the multimodal transportation means 1194, as shown in FIG. 11, the goods 705 are transported sequentially from the shipper by a truck S1 to a railway station through a first distance D1, and from a railway S2 through a second distance D2 to a loading port or a departure airport, from a cargo ship or a cargo plane S3 to an unloading port or a landing airport through a third distance D3, and then from another truck S4 to the recipient through a fourth distance D4. The multimodal transport loading bill 124 refers to a bill of lading that includes all above-mentioned transportation means, it is directly given by the sender to the recipient and applies to entire transportation, hence it eliminates a need for loading and unloading of the goods 705 and issuance of independent bills of lading at each transportation stage.

An operating process of the management system capable of automatically calculating the carbon emission value of the goods transportation and distribution according to the preferred embodiment of the present invention comprises:
(a1) an inputting step S101, wherein the input unit 10 is configured to input the expense write-off application form information 11 and the land waybill 121;
(a2) a comparing the carbon emission coefficient of transportation means step S102, wherein the transportation country, an energy type and the transportation means are entered from the expense write-off application form 11 and the land waybill 121, and carbon emission coefficient information/per ton-kilometer transportation is compared based on the transportation carbon emission coefficient database of various countries by using the vehicle per ton-kilometer carbon emission coefficient comparison module 211;
(a3) an automatically calculating transportation distance step S103, wherein an original, a destination and the transportation means are entered in the expense write-off application form 11 and the land waybill 121, and the automatic transportation distance calculation module 22 automatically calculates the transportation distance information between the two transportation places by connecting with the network (a unit is metric kilometers or imperial miles);
(a4) a calculating step S104: wherein the land transportation fee 311 is calculated through the computing unit 30 based on the land waybill 121, compared carbon emission coefficient information/per ton-kilometer transportation and an automatically calculated distance information between the two transportation places, the land transportation carbon emission value 321 is calculated by the computing unit 30; and
(a5) an outputting step S105, wherein the output unit 40 generates the expense write-off report 41 based on the land transportation fee 311, and the transportation carbon emission report 42 is generated based on the land transportation carbon emission value 321.

In another embodiment, an operating process of the management system capable of automatically calculating the carbon emission value of the goods transportation and distribution comprises:
(b1) an inputting step S201, wherein the input unit 10 is configured to input the expense write-off application form information 11 and the land waybill 121;
(b2) a comparing the carbon emission coefficient of transportation means step S202, wherein the transportation country, the energy type, and the transportation means are entered from the expense write-off application form 11 and the land waybill 121, and the carbon emission coefficient information per energy measurement unit of transportation (such as a carbon dioxide equivalent CO2e emitted per liter of gasoline or per kilowatt hour of electricity) is compared based on the transportation carbon emission coefficient database of various countries by using the vehicle per energy-measurement-unit energy type carbon emission coefficient comparison module 212;
(b3) a calculating step S203, wherein the land transportation fee 311 is calculated based on the land waybill 121 by using the computing unit 30, and the land transportation carbon emission value 321 is calculated based on compared carbon emission coefficient information per energy measurement unit of the transportation means and a total energy amount of the land waybill 121 by using the computing unit 30; and
(b4) an outputting step S204, wherein the output unit 40 generates the expense write-off report 41 based on the land transportation fee 311, and the transportation carbon emission report 42 is generated based on the land transportation carbon emission value 321.

In another embodiment, an operating process of the management system capable of automatically calculating the carbon emission value of the goods transportation and distribution comprises:
(c1) an inputting step S301, wherein the input unit 10 is configured to input the expense write-off application form information 11 and the sea waybill 122;
(c2) a calculating step S302, wherein the sea transportation fee 312 is calculated based on the sea waybill 122 by using the computing unit 30, and the sea transportation carbon emission value 322 is calculated based on entered information (such as the shipping company, the route, the loading port, a transit port, the unloading port, the cargo weight, the cargo volume, and the freight) of the expense write-off application form information 11 and the sea waybill 122 by connecting the computing unit 30 to the shipping company's carbon emission calculation module 33 to calculate the sea transportation carbon emission value 322; and (c3) an outputting step S303, wherein the output unit 40 generates the expense write-off report 41 based on the sea transportation fee 312, and the transportation carbon emission report 42 is generated based on the sea transportation carbon emission value 322.

In another embodiment, an operating process of the management system capable of automatically calculating the carbon emission value of the goods transportation and distribution comprises:
(d1) an inputting step S401, wherein the input unit 10 is configured to input the expense write-off application form information 11 and the air waybill 123;
(d2) a calculating step S402, wherein the air transportation fee 313 is calculated based on the air waybill 123 by using the computing unit 30, and the air transportation carbon emission value 323 is calculated based on entered information (such as the airline, the flight, the sender, a recipient, the departure airport, the relay airport, the landing airport, the cargo weight, the cargo volume, and the freight) of the expense write-off application form information 11 and the air waybill 123 by connecting the computing unit 30 to the airline carbon emission calculation module 34 to calculate the air transportation carbon emission value 323; and
(d3) an outputting step S403, wherein the output unit 40 generates the expense write-off report 41 based on the air transportation fee 313, and the transportation carbon emission report 42 is generated based on the air transportation carbon emission value 323.

In another embodiment, an operating process of the management system capable of automatically calculating the carbon emission value of the goods transportation and distribution comprises:
(e1) an inputting step S501, wherein the input unit 10 is configured to input at least two of the expense write-off application form information 11, the land waybill 121, the sea waybill 122 and the air waybill 123;
(e2) a comparing the carbon emission coefficient of transportation means step S502, wherein the transportation country, the energy type and the transportation means are entered from the expense write-off application form 11 and the land waybill 121, the carbon emission coefficient information of transportation vehicles per ton-kilometer is compared based on the transportation carbon emission coefficient database of various countries by using the vehicle per ton-kilometer carbon emission coefficient comparison module 211, or the carbon emission coefficient information per energy measurement unit of transportation is compared based on the transportation carbon emission coefficient database of various countries by using the vehicle per energy-measurement-unit energy type carbon emission coefficient comparison module 212 to obtain information on carbon emission coefficient per energy measurement unit of transportation vehicles;
(e3) an automatically calculating transportation distance step S503, wherein the original, the destination and the transportation means are entered in the expense write-off application form 11 and the land waybill 121, and the automatic transportation distance calculation module 22 automatically calculates the transportation distance information between the two transportation places by connecting with the network;
(e4) a calculating step S504, wherein the land transportation fee 311 is calculated through the computing unit 30 based on the land waybill 121, and/or the sea transportation fee 312 is calculated based on the sea waybill 122 by using the computing unit 30, and/or the air transportation fee 313 is calculated based on the air waybill 123 by using the computing unit 30, and based on the compared carbon emission coefficient information/per ton-kilometer transportation and the automatically calculated distance information between the two transportation places, or the carbon emission coefficient information per energy measurement unit of transportation, and the total energy amount of the land waybill 121, wherein the land transportation carbon emission value 321 is calculated by using the computing unit 30, and/or inputted information from the expense write-off application form information 11 and the sea waybill 122, and the sea transportation carbon emission value 322 is calculated by connecting the computing unit 30 to the shipping company's carbon emission calculation module 33, and/or inputted information from the expense write-off application form information 11 and the air waybill 123, the air transportation carbon emission value 323 is calculated by connecting the computing unit 30 to the airline carbon emission calculation module 34, and land transportation fee 311 is added to the sea transportation fee 312, or the land transportation fee 311 is added to the air transportation fee 313, or the land transportation fee 311, the sea transportation fee 312 and the air transportation fee 313 are added to form the transportation cost 31, and the land transportation carbon emission value 321 is added to the sea transportation carbon emission value 322 or the land transportation carbon emission value 321 is added to the air transportation carbon emission value 323 or the land transportation carbon emission value 321, the sea transportation carbon emission value 322 and the air transportation carbon emission value 323 are added to form the transportation carbon emission value 32 based on the land waybill 121 and the sea waybill 122 or the land waybill 121 and the air waybill 123 or the land waybill 121, the sea waybill 122 and the air waybill 123; and
(e5) an outputting step S505, wherein the output unit 40 generates the expense write-off report 41 based on the transportation cost 31, and the transportation carbon emission report 42 is generated based on the transportation carbon emission value 32.

In another embodiment, an operating process of the management system capable of automatically calculating the carbon emission value of the goods transportation and distribution comprises:
(f1) an inputting step S601, wherein the input unit 10 is configured to input the expense write-off application form information 11 and the multimodal transport loading bill 124;
(f2) a comparing transportation carbon emission coefficient step S602, wherein a combination of the expense write-off application form information 11 and the multimodal transport loading bill 124 of various transportation means (such as S1-S4 of FIG. 11), and departures and destinations of various transportation means of the various transportation means, wherein carbon emission value information is compared based on the carbon emission coefficient per ton-kilometer of the transportation means and the transportation distance information between the two transportation places (such as d1-d4 of FIG. 11) in the multimodal transportation means 1194;
(f3) a calculating step S603, wherein a multimodal transport cost 314 and a multimodal transport carbon emission value 324 is calculated by the computing unit 30 according to a result of the comparing transportation carbon emission coefficient step S602; and
(f4) an outputting step S604, wherein the output unit 40 generates the expense write-off report 41 based on the multimodal transport cost 314, and the transportation carbon emission report 42 is generated based on the multimodal transport carbon emission value 324.

When encountering the same multimodal transport vehicle 1194 in next time, it is only required to adjust an input cargo weight, thus automatically generating the expense write-off report 41 and the transportation carbon emission report 42.

Thereby, the operating process of the management system of the present invention has the following advantages:

The operating process is capable of integrating the upstream and downstream transportation and distribution digital systems to conduct a transportation and distribution carbon footprint verification. When using the operating process, the expense write-off application form information 11 and the B/L 12 are entered to automatically calculate the carbon emission value of the goods shipped by the land transportation, sea transportation, air transportation or multimodal transportation. It is helpful for enterprises to make transportation and distribution carbon emission encouragement and reward measures, and to improve the effectiveness of transportation and distribution carbon reduction in the enterprises.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A management system capable of automatically calculating a carbon emission value of goods transportation and distribution comprising:
an input unit configured to input expense write-off application form information and a bill of lading (B/L), wherein the B/L is at least one of a land waybill, a sea waybill and an air waybill, and the B/L is a multimodal transport loading bill, wherein the multimodal transport loading bill is a bill of at least two modes of transportation applicable for a land transportation, a sea transportation, and an air transportation;
a comparison calculation unit connected to the input unit and including a transportation carbon emission coefficient comparison module and an automatic transportation distance calculation module, wherein the transportation carbon emission coefficient comparison module includes a vehicle per ton-kilometer carbon emission coefficient comparison module which is configured to compare and obtain transportation means carbon emission coefficient information/per ton-kilometer, wherein the input unit is connected to the automatic transportation distance calculation module through a network to automatically calculate a distance information between two transportation places;
a computing unit connected with the input unit and the comparison calculation unit to perform calculations based on the B/L, thus obtaining a transportation cost and a transportation carbon emission value, wherein the transportation cost includes at least one of a land transportation fee, a sea transportation fee, and an air transportation fee, wherein the transportation carbon emission value includes at least one of a land transportation carbon emission value, a sea transportation carbon emission value, and an air transportation carbon emission value, wherein the land transportation carbon emission value is obtained by calculating a carbon emission coefficient per ton-kilometer of the transportation means and transportation distance information, the sea transportation carbon emission value is obtained through a carbon emission calculation module of an external shipping company, and the air transportation carbon emission value is obtained through a carbon emission calculation module of an external airline company; and
wherein an output unit connected to the computing unit to generate an expense write-off report based on the at least one of the land transportation fee, the sea transportation fee, and the air transportation fee, and the output unit is configured to generate a transportation carbon emission report by calculating the at least one of the land transportation carbon emission value, the sea transportation carbon emission value, and the air transportation carbon emission value.

2. The management system as claimed in claim 1 further comprising a check unit which includes a supervisor audit and a carbon emission audit, wherein the supervisor audit is configured to check the expense write-off report, and the carbon emission audit is configured to check the transportation carbon emission report.

3. The management system as claimed in claim 1 further comprising a write-off unit which includes an accounting write-off, wherein the accounting write-off is configured to perform an expense write-off based on the expense write-off report.

4. The management system as claimed in claim 1, wherein the transportation carbon emission coefficient comparison module includes a vehicle per energy-measurement-unit energy type carbon emission coefficient comparison module, wherein the vehicle per energy-measurement-unit energy type carbon emission coefficient comparison module is configured to compare and obtain the transportation means carbon emission coefficient/per energy measurement unit, and the vehicle per ton-kilometer carbon emission coefficient comparison module is configured to compare the carbon emission coefficient information per ton-kilometer of transportation based on transportation carbon emission coefficient database of various countries, wherein the transportation carbon emission coefficient database of each transportation country is dynamically updated over time, the comparison calculation unit is edited, and updated a latest carbon emission coefficient published by each transportation country and based on a built-in database, the land transportation carbon emission value, the sea transportation carbon emission value, the air transportation carbon emission value are saved and transmitted for supporting information of carbon emissions calculations.

5. The management system as claimed in claim 1, wherein the automatic transportation distance calculation module is an external program, and the carbon emission value of transportation and sea transportation is obtained through a network connection to the carbon emission calculation module of an external shipping company, wherein the carbon emission value of air transportation is obtained by a calculation of the carbon emission calculation module of an external airline connected to the network, the automatic calculation module of the transportation distance is a Google calculation sheet, and an input formula=GOOGLEMAPS_DISTANCE (“original place”, “destination”), let a function automatically calculates the distance, wherein an automatic transportation distance calculation module, a shipping company carbon emission calculation module and an airline carbon emission calculation module are designed with an interface based on XML (extensible Markup Language) to complete a data storage, and a data transmission so that an entire calculation operating process is automatically performed through a serialized XML interface.

6. An operating process of the management system capable of automatically calculating the carbon emission value of the goods transportation and distribution comprises:
an inputting step, wherein the input unit is configured to input the expense write-off application form information and at least one of the land waybill, the sea waybill, and the air waybill;
a comparing the carbon emission coefficient of transportation means step, wherein the transportation country, the energy type and the transportation means are entered from the expense write-off application form and the land waybill, the carbon emission coefficient information of transportation vehicles per ton-kilometer is compared based on the transportation carbon emission coefficient database of various countries by using the vehicle per ton-kilometer carbon emission coefficient comparison module, the carbon emission coefficient information per energy measurement unit of transportation is compared based on the transportation carbon emission coefficient database of various countries by using the vehicle per energy-measurement-unit energy type carbon emission coefficient comparison module to obtain information on carbon emission coefficient per energy measurement unit of transportation vehicles;
an automatically calculating transportation distance step, wherein the original, the destination and the transportation means are entered in the expense write-off application form and the land waybill, and the automatic transportation distance calculation module automatically calculates the transportation distance information between the two transportation places by connecting with the network;
a calculating step, wherein the land transportation fee is calculated through the computing unit based on the land waybill, and the sea transportation fee is calculated based on the sea waybill by using the computing unit, and the air transportation fee is calculated based on the air waybill by using the computing unit, and based on the compared carbon emission coefficient information per ton-kilometer transportation and the automatically calculated distance information between the two transportation places, and the carbon emission coefficient information per energy measurement unit of transportation, and the total energy amount of the land waybill, wherein the land transportation carbon emission value is calculated by using the computing unit, and inputted information from the expense write-off application form information and the sea waybill, and the sea transportation carbon emission value is calculated by connecting the computing unit to the shipping company's carbon emission calculation module, and inputted information from the expense write-off application form information and the air waybill, the air transportation carbon emission value is calculated by connecting the computing unit to the airline carbon emission calculation module; and
an outputting step, wherein the output unit generates an expense write-off report based on the land transportation fee, the sea transportation fee, the air transportation fee, and a transportation carbon emission report is generated based on the land transportation carbon emission value, the sea transportation carbon emission value, and the air transportation carbon emission value.

7. The operating process as claimed in claim 6, wherein in the comparing the carbon emission coefficient of transportation means step, the transportation carbon emission coefficient comparison module is used, wherein the transportation carbon emission coefficient comparison module includes a vehicle per energy-measurement-unit energy type carbon emission coefficient comparison module, wherein the vehicle per energy-measurement-unit energy type carbon emission coefficient comparison module is configured to compare and obtain the transportation means carbon emission coefficient per energy measurement unit, and the vehicle per ton-kilometer carbon emission coefficient comparison module is configured to compare the carbon emission coefficient information per ton-kilometer of transportation based on transportation carbon emission coefficient database of various countries, wherein the transportation carbon emission coefficient database of each transportation country is dynamically updated over time, the comparison calculation unit is edited, and updated a latest carbon emission coefficient published by each transportation country and based on a built-in database, the land transportation carbon emission value, the sea transportation carbon emission value, the air transportation carbon emission value are saved and transmitted for supporting information of carbon emissions calculations.

8. The operating process as claimed in claim 6, wherein in the automatically calculating transportation distance step, the automatic transportation distance calculation module is used, wherein the automatic transportation distance calculation module is an external program, and the carbon emission value of transportation and sea transportation is obtained through a network connection to the carbon emission calculation module of an external shipping company, wherein the carbon emission value of air transportation is obtained by a calculation of the carbon emission calculation module of an external airline connected to the network, the automatic calculation module of the transportation distance is a Google calculation sheet, and an input formula=GOOGLEMAPS_DISTANCE (“original place”, “destination”), let a function automatically calculates the distance, wherein an automatic transportation distance calculation module, a shipping company carbon emission calculation module and an airline carbon emission calculation module are designed with an interface based on XML (extensible Markup Language) to complete a data storage, and a data transmission so that an entire calculation operating process is automatically performed through a serialized XML interface.

9. An operating process of the management system capable of automatically calculating the carbon emission value of the goods transportation and distribution comprises:
an inputting step, wherein the input unit is configured to input the expense write-off application form information and at least two of the land waybill, the sea waybill, and the air waybill;
a comparing the carbon emission coefficient of transportation means step, wherein the transportation country, the energy type and the transportation means are entered from the expense write-off application form and the land waybill, the carbon emission coefficient information of transportation vehicles per ton-kilometer is compared based on the transportation carbon emission coefficient database of various countries by using the vehicle per ton-kilometer carbon emission coefficient comparison module, and the carbon emission coefficient information per energy measurement unit of transportation is compared based on the transportation carbon emission coefficient database of various countries by using the vehicle per energy-measurement-unit energy type carbon emission coefficient comparison module to obtain information on carbon emission coefficient per energy measurement unit of transportation vehicles;
an automatically calculating transportation distance step, wherein the original, the destination and the transportation means are entered in the expense write-off application form and the land waybill, and the automatic transportation distance calculation module automatically calculates the transportation distance information between the two transportation places by connecting with the network;
a calculating step, wherein the land transportation fee is calculated through the computing unit based on the land waybill, and the sea transportation fee is calculated based on the sea waybill by using the computing unit, and the air transportation fee is calculated based on the air waybill by using the computing unit, and based on the compared carbon emission coefficient information per ton-kilometer transportation and the automatically calculated distance information between the two transportation places, and the carbon emission coefficient information per energy measurement unit of transportation, and the total energy amount of the land waybill, wherein the land transportation carbon emission value is calculated by using the computing unit, and inputted information from the expense write-off application form information and the sea waybill, and the sea transportation carbon emission value is calculated by connecting the computing unit to the shipping company's carbon emission calculation module, and inputted information from the expense write-off application form information and the air waybill, the air transportation carbon emission value is calculated by connecting the computing unit to the airline carbon emission calculation module, and land transportation fee is added to the sea transportation fee, the land transportation fee is added to the air transportation fee, the land transportation fee, the sea transportation fee and the air transportation fee are added to form the transportation cost, and the land transportation carbon emission value is added to the sea transportation carbon emission value and the land transportation carbon emission value is added to the air transportation carbon emission value, and the land transportation carbon emission value, the sea transportation carbon emission value and the air transportation carbon emission value are added to form the transportation carbon emission value based on the land waybill. the sea waybill, and the air waybill; and
an outputting step, wherein the output unit generates the expense write-off report based on the transportation cost, and the transportation carbon emission report is generated based on the transportation carbon emission value.

10. The operating process as claimed in claim 9, wherein in the comparing the carbon emission coefficient of transportation means step, the transportation carbon emission coefficient comparison module is used, wherein the transportation carbon emission coefficient comparison module also includes a vehicle per energy-measurement-unit energy type carbon emission coefficient comparison module, wherein the vehicle per energy-measurement-unit energy type carbon emission coefficient comparison module is configured to compare and obtain the transportation means carbon emission coefficient per energy measurement unit, and the vehicle per ton-kilometer carbon emission coefficient comparison module is configured to compare the carbon emission coefficient information per ton-kilometer of transportation based on transportation carbon emission coefficient database of various countries, wherein the transportation carbon emission coefficient database of each transportation country is dynamically updated over time, the comparison calculation unit is edited, and updated a latest carbon emission coefficient published by each transportation country and based on a built-in database, the land transportation carbon emission value, the sea transportation carbon emission value, the air transportation carbon emission value are saved and transmitted for supporting information of carbon emissions calculations.

11. The operating process as claimed in claim 9, wherein in the automatically calculating transportation distance step, the automatic transportation distance calculation module is used, wherein the automatic transportation distance calculation module is an external program, and the carbon emission value of transportation and sea transportation is obtained through a network connection to the carbon emission calculation module of an external shipping company, wherein the carbon emission value of air transportation is obtained by a calculation of the carbon emission calculation module of an external airline connected to the network, the automatic calculation module of the transportation distance is a Google calculation sheet, and an input formula=GOOGLEMAPS_DISTANCE (“original place”, “destination”), let a function automatically calculates the distance, wherein an automatic transportation distance calculation module, a shipping company carbon emission calculation module and an airline carbon emission calculation module are designed with an interface based on XML (extensible Markup Language) to complete a data storage, and a data transmission so that an entire calculation operating process is automatically performed through a serialized XML interface.
